(19) United States
(12) Patent Application Publication
(10) Pub. No.: US 2016/0271696 A1
(43) Pub. Date: Sep. 22, 2016

(54) THREE-DIMENSIONAL FORMING APPARATUS AND THREE-DIMENSIONAL FORMING METHOD

(71) Applicant: SEIKO EPSON CORPORATION, Tokyo (JP)

(72) Inventor: Tomoyuki KAMAKURA, Matsumoto-shi (JP)

(21) Appl. No.: 15/066,212

(22) Filed: Mar. 10, 2016

(30) Foreign Application Priority Data
Mar. 17, 2015 (JP) 2015-053023

(51) Int. Cl. B22F 3/105; B22F 3/24; B22F 1/00

(52) U.S. Cl. CPC B22F 3/1055; B22F 1/0059; B22F 3/24; B22F 2003/247; B22F 2998/10; B33Y 10/00

(57) ABSTRACT

A three-dimensional forming apparatus includes: a material supplying unit that supplies a sinter material containing a metal powder and a binder to the stage; an energy irradiating unit that supplies the sinter material supplied from the material supplying unit with an energy capable of sintering the sinter material; and a driving unit that enables the material supplying unit and the energy irradiating unit to three-dimensionally move relative to the stage. The material supplying unit includes a material ejection section that supplies the sinter material in a predetermined amount. The energy irradiating unit includes an energy irradiation section that emits the energy. The material ejection section and the energy irradiation section are held to a single holder.

### BACKGROUND

1. Technical Field

The present invention relates to a three-dimensional forming apparatus, and a three-dimensional forming method.

2. Related Art

Methods for conveniently forming a three-dimensional shape using metallic materials are available, as disclosed in JP-A-2008-184622. The method for producing a three-dimensional-shape object disclosed in this publication uses a raw material metal paste containing a metal powder, a solvent, and an adhesion enhancer, and forms a laminar material layer using the metal paste. The laminar material layer is irradiated with a light beam to form a metal sintered layer or a metal molten layer. The formation of the material layer, and the irradiation of a light beam are repeated to laminate the sintered layer or the molten layer, and obtain the desired three-dimensional-shape object.

However, in the three-dimensional-shape object producing method described in JP-A-2008-184622, a light beam irradiates only portions of the material layer supplied in layers, and sinters or melts only these portions of the material layer to form an object, leaving the unirradiated portions of the material layer to be removed and wasted. Another drawback is that the material layer becomes incompletely sintered or melted in the vicinity of the regions irradiated with the predetermined light beam. Such incomplete portions adhere to the desirably sintered or melted portions of the material layer, and make the object shape unstable.

A possible solution to the problems of JP-A-2008-184622 is to use a nozzle that can form a metal overlay by applying a laser to a powdery metallic material as the material is supplied to the desired location through the nozzle, as disclosed in JP-A-2005-219060 or JP-A-2013-75308.

The nozzles disclosed in JP-A-2005-219060 and JP-A-2013-75308 include a laser irradiation section at a central portion of the nozzle, and a powder supply section for supplying a metal powder (powder) is provided around the laser irradiation section. The powder is supplied toward the laser applied by the laser irradiation section from the nozzle center, and the laser melts the supplied powder to form a metal overlay on the object being formed.

It is, however, difficult to reduce the particle size of the meal powder used to form a metal overlay with the nozzles disclosed in JP-A-2005-219060 and JP-A-2013-75308. Specifically, the adhesion between particles increases as the particle size of the powder is made smaller to make what is commonly called fine particle, and this creates a so-called strongly adhesive powder, which easily adheres to a channel, for example, upon being transported and blown with compressed air or the like. This seriously impairs fluidity, and the ejection stability suffers. That is, there is a limit to reducing the powder particle size if the powder fluidity is to be maintained, and the nozzles disclosed in JP-A-2005-219060 and JP-A-2013-75308 cannot be readily used to form a three-dimensional shape at the levels of fineness and precision that can only be achieved with a fine particle-size powder.

### SUMMARY

An advantage of some aspects of the invention is to provide a three-dimensional forming apparatus and a three-dimensional forming method that allow for use of a fine particle-size metal powder to enable formation of a fine three-dimensional object.

The invention can be implemented as the following forms or application examples.

### Application Example 1

A three-dimensional forming apparatus according to this application example includes: a stage; a material supplying unit that supplies a sinter material containing a metal powder and a binder toward the stage; an energy irradiating unit that supplies the sinter material supplied from the material supplying unit with an energy capable of sintering the sinter material; and a driving unit that enables the material supplying unit and the energy irradiating unit to three-dimensionally move relative to the stage, the material supplying unit including a material ejection section that supplies the sinter material in a predetermined amount, the energy irradiating unit including an energy irradiation section that emits the energy, the material ejection section and the energy irradiation section being held to a single holder.

In the three-dimensional forming apparatus according to this application example, the sinter material is supplied in a necessary amount to the region where the three-dimensional-shape object is to be shaped, and the energy irradiating unit supplies energy to the supplied sinter material. In this way, the loss of supplied material and supplied energy can be reduced.

When supplying and sintering a metal powder alone, the adhesion between the metallic fine particles increases, and this creates a strongly adhesive powder, which easily adheres to a channel, for example, upon being transported and blown with compressed air or the like. This may seriously impair fluidity, and there is a limit to reducing the particle size of the metallic fine particle in the related art. However, with the configuration in which the sinter material as a kneaded mixture of a metal powder and a binder is supplied onto the stage from the material supplying unit, the adhesion to the material transport channel can be prevented, and the material can be stably supplied. This makes it possible to form a three-dimensional-shape object using an ultrafine metal powder.

As used herein, “capable of sintering” means that the supplied energy to the supply material evaporates the binder forming the supply material, and causes the remaining metal powders to bind to each other. In this specification, binding of metal powders through melting also represents a form of sintering that causes the metal powders to bind to each other under the supplied energy.

### Application Example 2

In the application example, the energy irradiating unit applies the energy in a direction that crosses the direction of gravity.

According to this application example, the energy needed to sinter the sinter material supplied from the material supplying unit can be applied without having to move the material supplying unit and the energy irradiating unit relative to each other.

Because the energy irradiation section applies energy rays in a direction that crosses the direction of gravity, for example, the energy rays reflected at the stage do not propagate toward the energy irradiation section. This makes it possible to prevent the reflected energy rays from damaging the energy irradiation section.

### Application Example 3

In the application example, the sinter material is ejected in a droplet through an orifice of the material ejection section.

According to this application example, with the sinter material supplied in the form of micro droplets and sintered on the stage, a three-dimensional-shape object can be formed as an aggregate of micro shape sinters. This makes it possible to form fine portions, and easily obtain a small, precision three-dimensional-shape object.

### Application Example 4

In the application example, the energy irradiation section includes a plurality of the energy irradiation sections.

According to this application example, the energy can be evenly supplied to the sinter material supplied onto the stage.

### Application Example 5

In the application example, the material supplying unit includes at least a material supply section that supplies the sinter material to the material ejection section having a material ejection orifice facing the stage, and the material supply section includes a plurality of the material supply sections, and supplies the sinter material as two or more sinter materials of different compositions.

According to this application example, sinter materials of different compositions can be supplied from the material supplying unit. With the material supplying unit supplying materials of different compositions, the energy irradiating unit can sinter or melt different materials. This makes it possible to easily form an object made of two or more composition materials.

### Application Example 6

In the application example, the energy irradiating unit is a laser irradiation unit.

According to this application example, the applied energy can be concentrated on the target supply material, and a quality three-dimensional-shape object can be formed. It also becomes easier to control the applied energy amounts (power, scan rate) according to, for example, the type of the sinter material, and obtain a three-dimensional-shape object of the desired quality.

### Application Example 7

A three-dimensional forming method according to this application example includes: forming a monolayer by supplying a sinter material containing a metal powder and a binder, and sintering the sinter material with an energy capable of sintering the sinter material and that is supplied toward the sinter material supplied in the supplying; and laminating another monolayer, on the monolayer formed in the forming, by forming the another monolayer by repeating the forming, in which the laminating is repeated a predetermined number of times to form a three-dimensional-shape object, and in the forming, the sinter material is ejected in a droplet in the supplying, and the sintering is performed to a landed unit droplet material of the sinter material over a predetermined formation region of the monolayer.

In the three-dimensional forming method according to this application example, the sinter material is supplied in a necessary amount to the region where the three-dimensional-shape object is to be shaped, and the energy irradiating unit supplies energy to the supplied sinter material. In this way, the loss of supplied material and supplied energy can be reduced.

When supplying and sintering a metal powder alone, the adhesion between the metallic fine particles increases, and this creates a strongly adhesive powder, which easily adheres to a channel, for example, upon being transported and blown with compressed air or the like. This may seriously impair fluidity, and there is a limit to reducing the particle size of the metallic fine particle in the related art. However, with the configuration in which the sinter material as a kneaded mixture of a metal powder and a binder is supplied onto the stage from the material supplying unit, the adhesion to the material transport channel can be prevented. This makes it possible to form a three-dimensional-shape object using an ultrafine metal powder.

### Application Example 8

In the application example, the energy supplied in the sintering is supplied by being applied in a direction that crosses the direction of gravity.

According to this application example, the energy needed to sinter the sinter material supplied from the material supplying unit can be applied without having to move the material supplying unit and the energy irradiating unit relative to each other.

### Application Example 9

In the application example, a support portion that supports the monolayer is formed in the forming, and the support portion is an unsintered portion unirradiated with the energy supplied in the sintering.

According to this application example, with the support portion formed as a material supply surface, an overhang portion, when formed as a portion beneath which a three-dimensional-shape object is absent in the direction of gravity, can be prevented from being deformed in the direction of gravity, and a three-dimensional-shape object of the desired shape can be formed.

### Application Example 10

In the application example, the method includes removing the support portion.

Because the support portion is an unsintered portion, it can be easily removed. The support portion, regardless of where it is formed, thus does not interfere with the formation of the three-dimensional-shape object as a finished product, and a three-dimensional-shape object of a precise shape can be obtained.

### BRIEF DESCRIPTION OF THE DRAWINGS

The invention will be described with reference to the accompanying drawings, wherein like numbers reference like elements.

FIG. 1 is a schematic block diagram representing a configuration of a three-dimensional forming apparatus according to First Embodiment.

FIGS. 2A and 2B show a holder of the three-dimensional forming apparatus according to First Embodiment, in which FIG. 2A is a side external view, and FIG. 2B is a top external view.

FIGS. 3A to 3E are schematic diagrams explaining the relationship between laser irradiation angle and the applied energy to a unit material, in which FIGS. 3A and 3B show an irradiation state of a first laser irradiation section, FIGS. 3C and 3D show an irradiation state of a second laser irradiation section, and FIG. 3E is a diagram combining the irradiation regions shown in FIGS. 3B and 3D.

FIG. 4 is a schematic block diagram representing another configuration of a laser irradiation section and a material supply section according to First Embodiment.

FIG. 5 is a schematic block diagram representing a configuration of a three-dimensional forming apparatus according to Second Embodiment.

FIGS. 6A and 6B show a holder of the three-dimensional forming apparatus according to Second Embodiment, in which FIG. 6A is an external plan view, and FIG. 6B is an external side view.

FIG. 7A is a flowchart representing a three-dimensional forming method according to Third Embodiment, and FIG. 7B is a flowchart representing the monolayer forming step of FIG. 7A in detail.

FIGS. 8A to 8C are partial cross sectional views representing steps of the three-dimensional forming method according to Third Embodiment.

FIGS. 9D and 9E are partial cross sectional views representing steps of the three-dimensional forming method according to Third Embodiment.

FIGS. 10A to 10C are partial cross sectional views representing steps of the three-dimensional forming method according to Third Embodiment.

FIGS. 11D and 11E are partial cross sectional views representing steps of the three-dimensional forming method according to Third Embodiment.

FIGS. 12A and 12B are diagrams representing a three-dimensional-shape object formed by using a three-dimensional forming method according to Fourth Embodiment, in which FIG. 12A is a plan external view, and FIG. 12B is a cross sectional view taken at A-A′ of FIG. 12A.

FIG. 13 is a flowchart representing the three-dimensional forming method according to Fourth Embodiment.

FIGS. 14A to 14D are cross sectional views and plan views representing steps of the three-dimensional forming method according to Fourth Embodiment.

### DESCRIPTION OF EXEMPLARY EMBODIMENTS

Embodiments of the invention are described below with reference to the accompanying drawings.

### First Embodiment

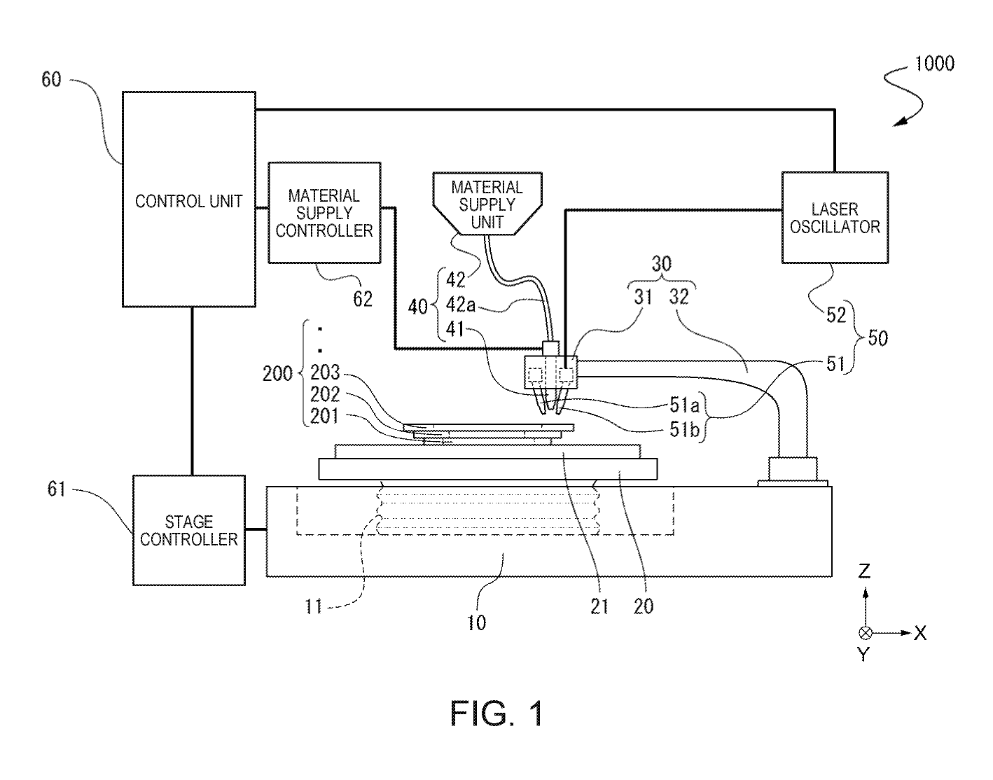

FIG. 1 is a schematic block diagram representing a configuration of a three-dimensional forming apparatus according to First Embodiment. As used herein, “three-dimensional forming” is intended to mean formation of what is generally called three-dimensional object, and encompasses formation of, for example, a flat object, or a two-dimensional shape, having a thickness.

As illustrated in FIG. 1, a three-dimensional forming apparatus 1000 includes a base 10, a stage 20 that is drivable in X, Y, and Z directions in the figure with a driving unit 11 provided as a driving unit in the base 10, and a head supporting unit 30. The head supporting unit 30 includes a head 31 provided as a holder for holding a material supplying unit and an energy irradiating unit (described later), and a support arm 32 fixed at one end to the base 10, and holding and fixing the head 31 at the other end. The following descriptions of the embodiment are based on the configuration in which the driving unit 11 drives the stage 20 in X, Y, and Z directions. However, the invention is not limited to this embodiment, and may adapt other configurations, as long as the stage 20 and the head 31 are drivable in X, Y, and Z directions relative to each other.

In the process of forming a three-dimensional-shape object 200, partial objects 201, 202, and 203 are formed in layers on the stage 20. Because the formation of the three-dimensional-shape object 200 involves the heat energy of laser irradiation, a heat-resistant sample plate 21 may be used to protect the stage 20 from heat, and the three-dimensional-shape object 200 may be formed on the sample plate 21. For example, by using a ceramic plate, the sample plate 21 can have high heat resistance, and low reactivity to the sintered or melted supply material, making it possible to prevent the three-dimensional-shape object 200 from being altered. For convenience of explanation, FIG. 1 illustrates only three partial objects, 201, 202, and 203. However, the partial objects are laminated until the desired shape is obtained for the three-dimensional-shape object 200.

A material ejection section 41 provided in a material supply device 40 (material supplying unit), and a laser irradiation section 51 (energy irradiation section) provided in a laser irradiation device 50 are held at the head 31. In the present embodiment, the laser irradiation section 51 includes a first laser irradiation section 51a, and a second laser irradiation section 51b.

The three-dimensional forming apparatus 1000 includes a control unit 60 (controller) that controls the stage 20, the material ejection section 41 provided in the material supply device 40, and the laser irradiation device 50 using, for example, the output creation data for the three-dimensional-shape object 200 from a data output device such as a personal computer (not illustrated). The control unit 60 includes at least a drive control section for the stage 20, an operation control section for the material ejection section 41, and an operation control section for the laser irradiation device 50, though these are not illustrated in the figure. The control unit 60 also includes a control section that cooperatively drives and operates the stage 20, the material ejection section 41, and the laser irradiation device 50.

Using control signals from the control unit 60, a state controller 61 generates signals that control the stage 20 with respect to, for example, start and stop of movement, direction of movement, amount of movement, and rate of movement. The signals are sent to the driving unit 11 provided in the base 10, and the stage 20 movably provided in the base 10 moves in the X, Y, and Z directions shown in the figure.

Using control signals from the control unit 60, a material supply controller 62 generates signals that control the material ejection section 41 with respect to, for example, material ejection amount, and the material ejection section 41 fixed to the head 31 ejects a predetermined amount of material according to the generated signals.

A supply tube 42a (material supply path) extends from the material supply unit 42 provided in the material supply device 40, and connects to the material ejection section 41. The material supply unit 42 stores a sinter material (supply material) containing a raw material of the three-dimensional-shape object 200 created in the three-dimensional forming apparatus 1000 according to the present embodiment. The sinter material (supply material) is a slurry-like (paste-like) mixed material of the raw material metal of the three-dimensional-shape object 200, for example, a simple powder of magnesium (Mg), iron (Fe), cobalt (Co), chromium (Cr), aluminum (Al), titanium (Ti), or nickel (Ni), or a mixed powder such as an alloy containing at least one of these metals, kneaded with a solvent and a thickener (binder).

The metal powder has an average particle size of preferably 10 μm or less. Examples of the solvent or dispersion medium include various types of water, such as distilled water, purified water, and RO water; alcohols such as methanol, ethanol, 2-propanol, 1-butanol, 2-butanol, octanol, ethylene glycol, diethylene glycol, and glycerine; ethers (cellosolves) such as ethylene glycol monomethyl ether (methylcellosolve), ethylene glycol monoethyl ether (ethylcellosolve), and ethylene glycol monophenyl ether (phenylcellosolve); esters such as methyl acetate, ethyl acetate, butyl acetate, and ethyl formate; ketones such as acetone, methyl ethyl ketone, diethyl ketone, methyl isobutyl ketone, methyl isopropyl ketone, and cyclohexanone; aliphatic hydrocarbons such as pentane, hexane, and octane; cyclic hydrocarbons such as cyclohexane, and methylcyclohexane; aromatic hydrocarbons having a long-chain alkyl group and a benzene ring, such as benzene, toluene, xylene, hexylbenzene, heptylbenzene, octylbenzene, nonylbenzene, decylbenzene, undecylbenzene, dodecylbenzene, tridecylbenzene, and tetradecylbenzene; halogenated hydrocarbons such as methylene chloride, chloroform, carbon tetrachloride, and 1,2-dichloroethane; aromatic heterocyclic rings such as pyridine, pyrazine, furan, pyrrole, thiophene, and methylpyrrolidone; nitriles such as acetonitrile, propionitrile, and acrylonitrile; amides such as N,N-dimethylformamide, and N,N-dimethylacetamide; carboxylic acid salts; and various oils.

The thickener is not particularly limited, as long as it is soluble in the solvent or dispersion medium. The thickener may use, for example, acrylic resin, epoxy resin, silicone resin, cellulose resin, or synthetic resin. It is also possible to use thermoplastic resins such as PLA (polylactic acid), PA (polyamide), and PPS (polyphenylene sulfide). When using a thermoplastic resin, the material ejection section 41 and the material supply unit 42 are heated to keep the thermoplastic resin flexible. Fluidity can be improved by using a heat-resistant solvent such as silicone oil.

The laser irradiation section 51 provided in the laser irradiation device 50 and fixed to the head 31 applies a laser beam as a laser oscillator 52 oscillates a laser of a predetermined output according to control signals from the control unit 60. The laser irradiates the supply material ejected through the material ejection section 41, and solidifies the metal powder contained in the supply material by sintering or melting the metal power. Here, the solvent and the thickener contained in the supply material evaporate under the heat of the laser. The laser used in the three-dimensional forming apparatus 1000 according to the present embodiment is not particularly limited. However, a fiber laser or a carbon dioxide gas laser is preferred for their long wavelengths and high metal absorption efficiency. Fiber lasers are more preferred for their ability to save creation time with their high laser output.

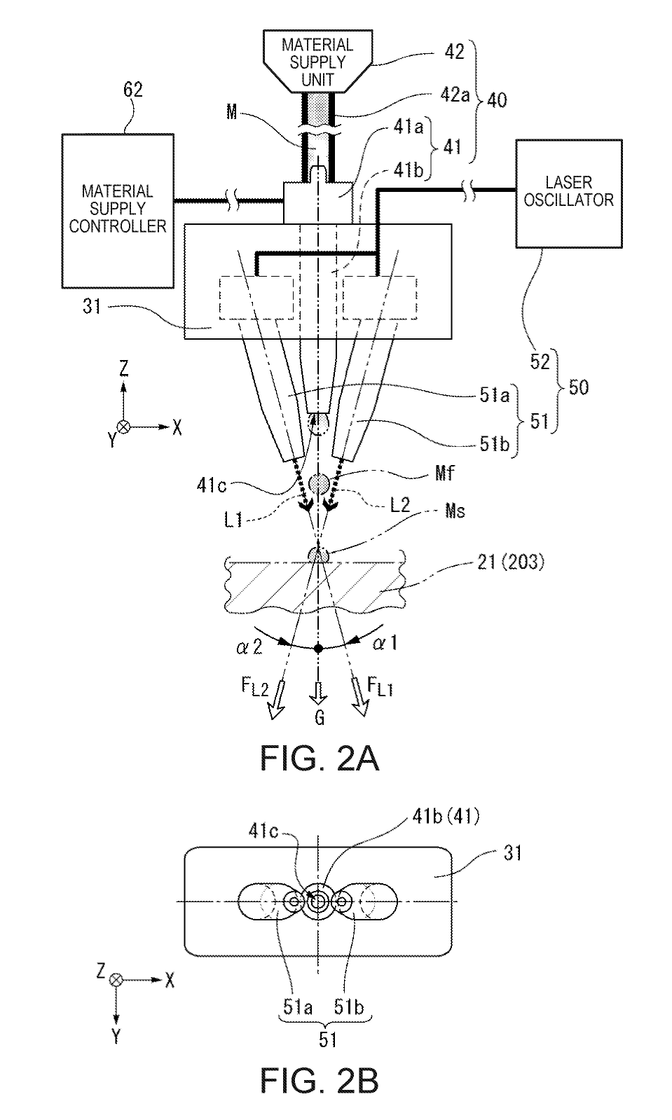

FIGS. 2A and 2B are magnified external views of the head 31 shown in FIG. 1, and the material ejection section 41 and the laser irradiation section 51 held to the head 31. FIG. 2A is an external view as viewed in the Y direction of FIG. 1. FIG. 2B is an external view as viewed in the Z direction of FIG. 1.

As illustrated in FIG. 2A, the material ejection section 41 held to the head 31 includes an ejection nozzle 41b, and an ejection drive section 41a that causes a predetermined amount of material to eject through the ejection nozzle 41b. The ejection drive section 41a is connected to the supply tube 42a joined to the material supply unit 42, and sinter material M is supplied through the supply tube 42a. The ejection drive section 41a includes an ejection drive device (not illustrated), and sends the sinter material M to the ejection nozzle 41b using control signals from the material supply controller 62.

The sinter material M ejected through the ejection orifice 41c of the ejection nozzle 41b is expelled in droplets, specifically, in the form of airborne material Mf of a substantially spherical shape toward the sample plate 21, or the uppermost partial object 203 (FIG. 1). The airborne material Mf lands on the sample plate 21 or on the partial object 203, and forms a unit droplet material Ms (hereinafter, “unit material Ms”) on the sample plate 21, or on the partial object 203.

The first laser irradiation section 51a and the second laser irradiation section 51b emit a laser L1 and a laser L2, respectively, toward the unit material Ms. The laser L1 and the laser L2 heat and calcine the unit material Ms.

Preferably, the airborne material Mf ejected through the ejection orifice 41c is ejected through the ejection orifice 41c in the direction of gravity G indicated by arrowhead in the figure. Specifically, by being ejected in the direction of gravity G, the airborne material Mf can be reliably expelled toward the landing position, and the unit material Ms can be disposed at the desired location. The lasers L1 and L2 that irradiate the unit material Ms ejected and landed in the direction of gravity G are emitted in directions that cross the direction of gravity G. Specifically, the first laser irradiation section 51a emits the laser L1 in an irradiation direction FL1 that makes an angle α1 with the direction of gravity G as shown in the figure, and irradiates the unit material Ms. Similarly, the second laser irradiation section 51b emits the laser L2 in an irradiation direction FL2 that makes an angle α2 with the direction of gravity G as shown in the figure, and irradiates the unit material Ms.

As described above, the material supply device 40 of the three-dimensional forming apparatus 1000 according to the present embodiment ejects the airborne material Mf in droplets through the material ejection section 41. In blowing a metal fine powder through a material supply port and sintering the metal fine powder with energy rays such as a laser beam as in the related art, the adhesion between the particles increases, and this creates a so-called strongly adhesive powder, which easily adheres to a channel, for example, upon being transported and blown with compressed air or the like, and seriously impairs fluidity. In the present embodiment, however, a metal fine powder having an average particle size of 10 μm or less, kneaded with a solvent and a thickener is used as sinter material M, and excellent fluidity can be imparted.

Because of the high fluidity, the sinter material M can be ejected in droplets through the ejection orifice 41c of the material ejection section 41 in minute amounts, and the unit material Ms can be disposed on the sample plate 21, or on the partial object 203. Specifically, a fine three-dimensional object can be formed as a continuous object of finer units made of minute amounts of the material.

Because the lasers L1 and L2 are applied toward the location of the unit material MS in directions FL1 and FL2 that cross the direction of gravity, the unit material Ms can be irradiated with the lasers L1 and L2 without moving the head 31 relative to the sample plate 21 or the partial object 203.

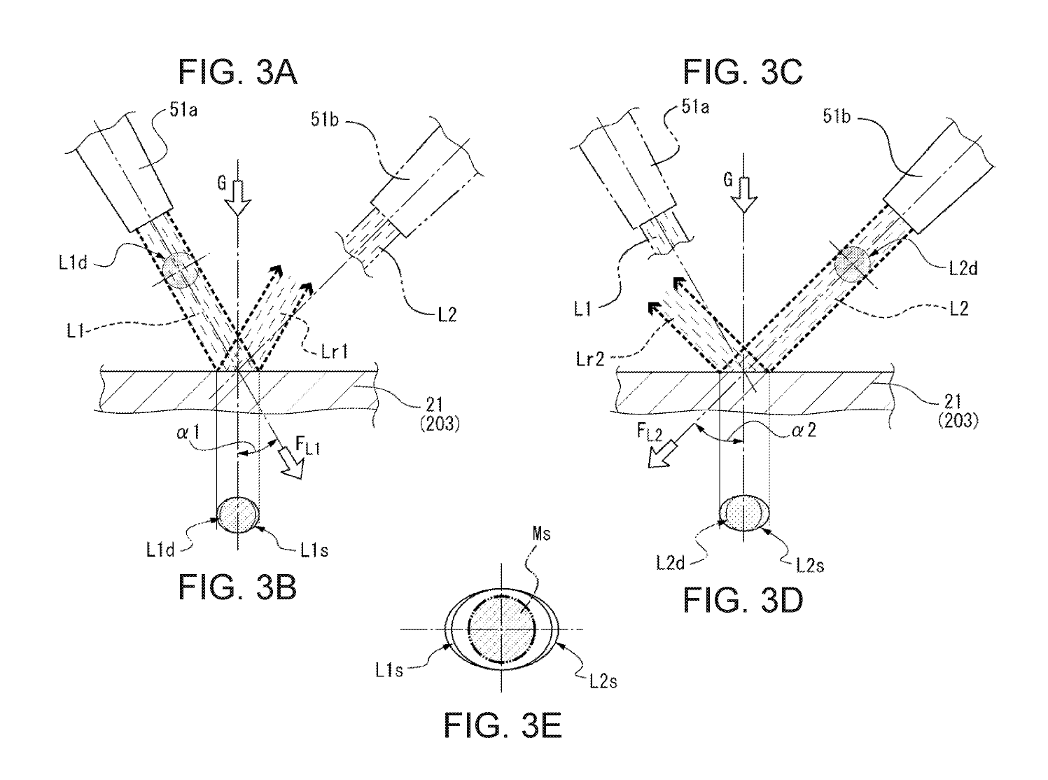

FIGS. 3A to 3E are schematic diagrams explaining the relationship between the irradiation angles α1 and α2 of the lasers L1 and L2, and the irradiation energy on the unit material Ms. FIGS. 3A and 3B show the first laser irradiation section 51a, and the laser L1 being emitted by the first laser irradiation section 51a. FIGS. 3C and 3D show the second laser irradiation section 51b, and the laser L2 being emitted by the second laser irradiation section 51b. FIG. 3E shows an irradiation region being irradiated with the lasers L1 and L2, specifically a combined view of FIGS. 3B and 3D.

As illustrated in FIG. 3A, the first laser irradiation section 51a emits the laser L1 toward the top surface of the sample plate 21 or the partial object 203 in direction FL1 that makes an angle α1 with respect to the direction of gravity G. The laser L1 emitted by the first laser irradiation section 51a forms a substantially circular laser emission shape L1d in a cross section orthogonal to the emission direction FL1. Upon the laser L1 reaching the top surface of the sample plate 21 or the partial object 203, the laser emission shape L1d becomes an elliptical laser irradiation shape L1s, which varies with the angle α1 of the irradiation direction FL1, as shown in FIG. 3B.

Similarly, the second laser irradiation section 51b emits the laser L2 toward the top surface of the sample plate 21 or the partial object 203 in direction FL2 that makes an angle α2 with respect to the direction of gravity G, as shown in FIG. 3C. The laser L2 emitted by the second laser irradiation section 51b forms a substantially circular laser emission shape L2d in a cross section orthogonal to the emission direction FL2. Upon the laser L2 reaching the top surface of the sample plate 21 or the partial object 203, the laser emission shape L2d becomes an elliptical laser irradiation shape L2s, which varies with the angle α2 of the irradiation direction FL2, as shown in FIG. 3D. The unit material Ms (see FIGS. 2A and 2B) that has landed on the top surface of the sample plate 21 or the partial object 203 is then irradiated with the lasers L1 and L2 within the region of the laser irradiation shapes L1s and L2s, as shown in FIG. 3E.

The lasers L1 and L2 emitted in directions FL1 and FL2 that cross the direction of gravity G in the manner described above are reflected at the sample plate 21 or the partial object 203, and become reflected lasers Lr1 and Lr2, respectively, that propagate in the opposite angle directions with respect to the axis line of the direction of gravity G, as shown in FIGS. 3A and 3C. That is, the reflected lasers Lr1 and Lr2 of the lasers L1 and L2 do not propagate into the laser irradiation sections 51a and 51b, and do not damage the laser irradiation sections 51a and 51b.

The three-dimensional forming apparatus 1000 according to First Embodiment has been described with respect to the configuration with two laser irradiation sections 51a and 51b. However, the invention is not limited to this configuration, and may include, for example, only one laser irradiation section, or three or more laser irradiation sections. The invention is also not limited to the configuration in which the laser irradiation sections 51a and 51b are installed in the head 31 in a manner that allows the lasers L1 and L2 to be applied in directions FL1 and FL2 that cross the direction of gravity G.

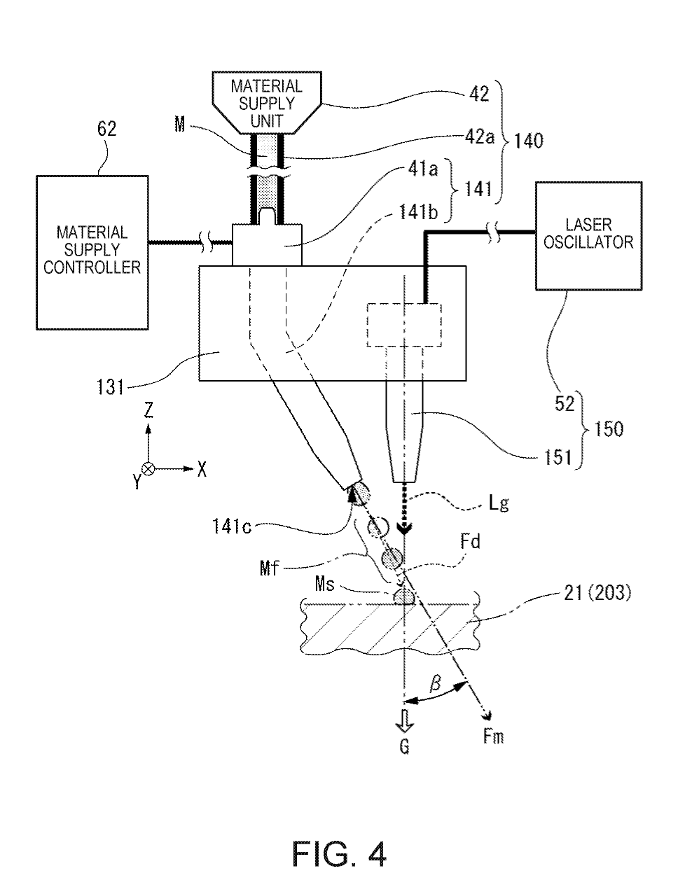

FIG. 4 is a partial schematic block diagram representing another embodiment of the laser irradiation section 51 and the material ejection section 41 in the three-dimensional forming apparatus 1000 according to First Embodiment. The same constituting elements already described in the three-dimensional forming apparatus 1000 above are given the same reference numerals, and will not be described further.

In the head 131 shown in FIG. 4 are installed a laser irradiation section 151 that applies a laser Lg in the direction of gravity G, and an ejection nozzle 141b that has an ejection orifice 141c through which the sinter material M is ejected as droplets of airborne material Mf toward the irradiation position of the laser Lg on the sample plate 21 or the partial object 203 in a direction Fm that crosses the direction of gravity.

Upon the sinter material M being ejected through the ejection orifice 141c in direction Fm, the airborne material Mf flies in a parabolic flight path Fd under the force of gravity, and lands as unit material Ms. Accordingly, the material ejection section 141 and the laser irradiation section 151 are installed in the head 131 in such a manner that the laser Lg irradiates the region on the sample plate 21 or the partial object 203 where the flight path Fd meets.

The laser irradiation direction and the sinter material ejection direction may be crossed as in the configuration above. In such a configuration, the laser Lg reflected at the sample plate 21 or the partial object 203 has the possibility of entering the laser irradiation section 151. However, because the laser Lg is applied in the direction of gravity G, the laser irradiation position can be controlled at very high precision to enable high energy density irradiation. By controlling the laser Lg and making a fine laser emission shape (corresponding to the laser emission shapes L1d and L2d shown in FIGS. 3A and 3C), the reflected laser can be diffused at the surface of the unit material Ms, and the amount of the light energy reflected toward the laser irradiation section 151 can be attenuated.

In the three-dimensional forming apparatus 1000 according to First Embodiment, the sinter material obtained by kneading a metal fine powder, a thickener, and a solvent is ejected in droplets to form a unit droplet material (Ms in FIG. 2A) on the sample plate 21 or on the uppermost partial object, for example, the partial object 203 shown in FIG. 1, and the material is sintered with a laser. Specifically, the sinter material obtained by kneading a metal fine powder, a thickener, and a solvent is formed into ultrafine droplets to form a unit object, and a three-dimensional-shape object 200 is formed as a continuous object made of the ultrafine unit objects. This makes it possible to easily form a fine-shaped three-dimensional-shape object.

By being kneaded with a thickener and a solvent, the raw material metal fine powder of the three-dimensional-shape object does not adhere to the sinter material supply channel, or become a so-called strongly adhesive powder, even when the powder has an ultrafine particle size. The powder can thus move through the supply path with fluidity. This makes it possible to reduce the particle size of the metal fine powder, and form a fine three-dimensional-shape object. It is also possible to make a dense object.

The three-dimensional forming apparatus 1000 according to the present embodiment has been described through the case of using lasers L1 and L2 as the radiation energy. However, the invention is not limited to this embodiment. For example, an energy source such as radio frequency, and a halogen lamp may be used, provided that it can supply the heat to sinter the sinter material M.

### Second Embodiment

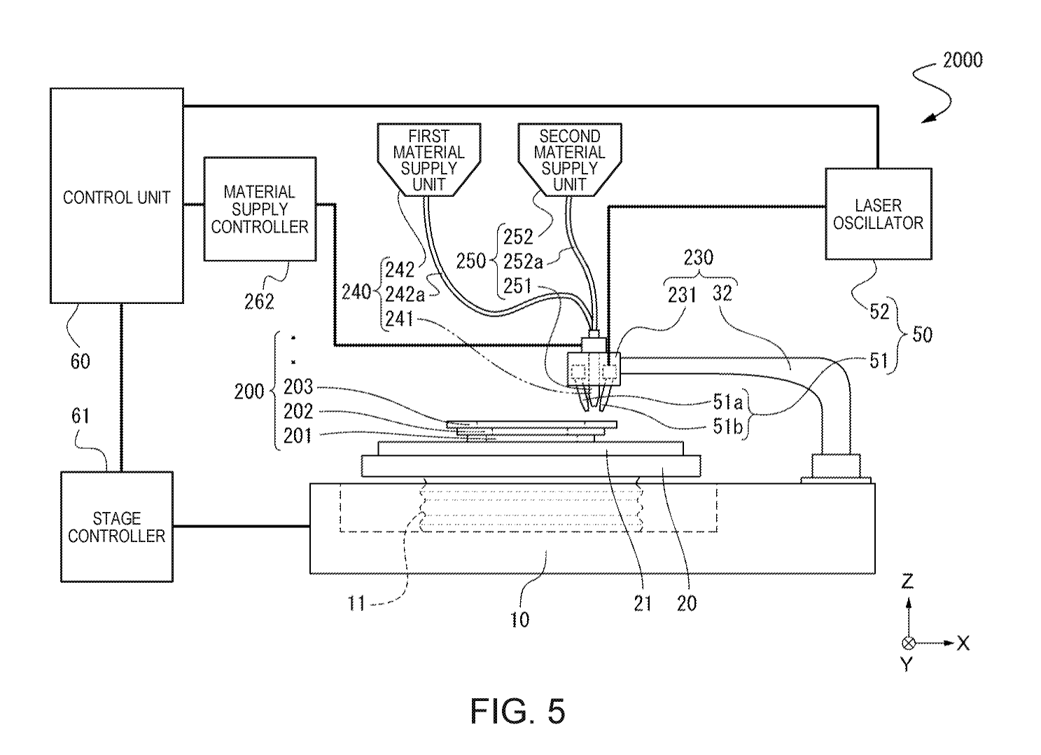

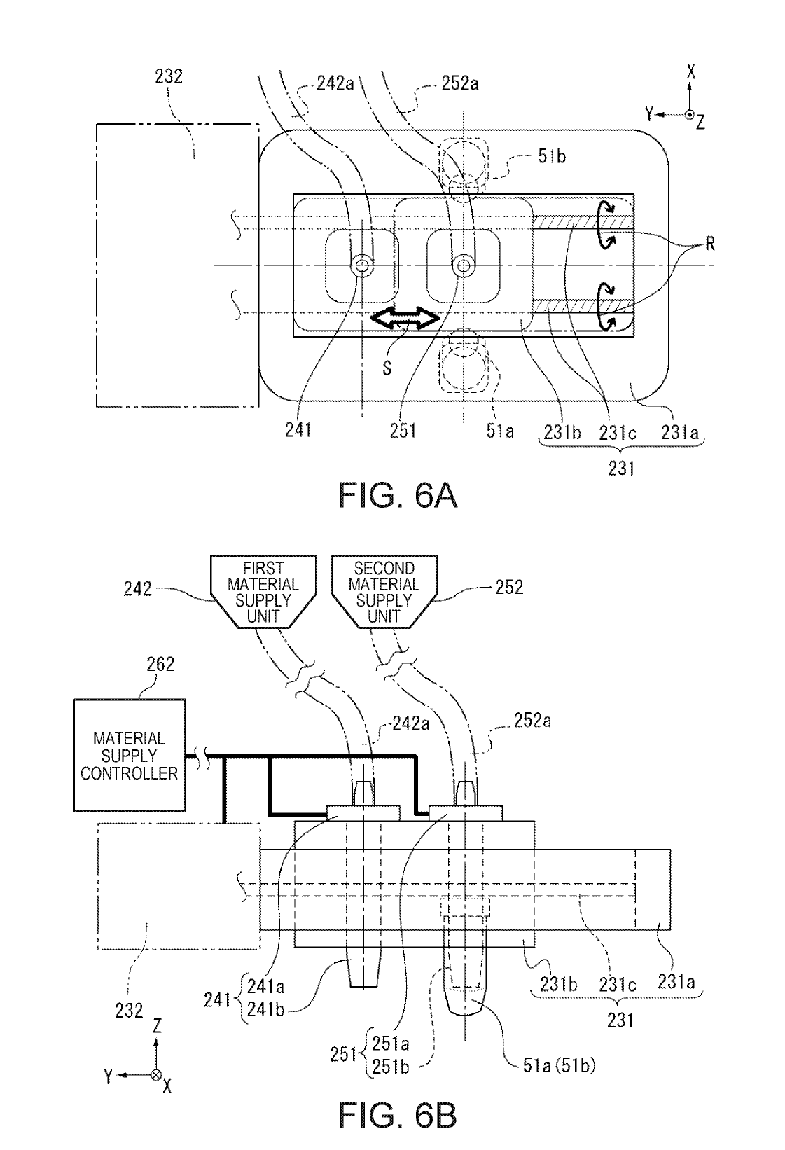

FIG. 5 is a schematic block diagram representing a three-dimensional forming apparatus 2000 according to Second Embodiment that uses a plurality of sinter materials to form a three-dimensional object. FIGS. 6A and 6B show a detailed configuration of a head 231. FIG. 6A is an external plan view of the head 231 as viewed from above in the Z direction shown in FIG. 5. FIG. 6B is an external side view in the direction of X axis. The three-dimensional forming apparatus 2000 differs from the three-dimensional forming apparatus 1000 of First Embodiment in the configuration of the material supply device 40. The same constituting elements are given the same reference numerals, and will not be described further.

As illustrated in FIG. 5, the three-dimensional forming apparatus 2000 according to Second Embodiment includes two material supplying units—a first material supply device 240 and a second material supply device 250. The first material supply device 240 includes a first material supply unit 242, a first supply tube 242a, and a first material ejection section 241 joined to the first supply tube 242a and held to the head 231. Similarly, the second material supply device 250 includes a second material supply unit 252, a second supply tube 252a, and a second material ejection section 251 joined to the second supply tube 252a and held to the head 231.

The head 231 includes a movable head 231b on a head body 231a, as illustrated in FIG. 6A. In the present embodiment, the movable head 231b includes drive screw shafts 231c disposed on the head body 231a so as to be rotatably driven, and a driving unit 232 for rotatably driving the drive screw shafts 231c. The movable head 231b has screw fitting portions with which the movable head 231b can make reciprocal movement in S directions along the direction of Y axis shown in the figure as the drive screw shafts 231c rotate in rotation directions R.

A first ejection nozzle 241b and a second ejection nozzle 251b are held to the movable head 231b. A first laser irradiation section 51a and a second laser irradiation section 51b of a laser irradiation device 50 are held to the head body 231a.

In the head 231 of the three-dimensional forming apparatus 2000 according to present embodiment illustrated in FIGS. 6A and 6B, the second ejection nozzle 251b is disposed by moving the movable head 231b to a position corresponding to the irradiation position of the laser irradiation sections 51a and 51b. As illustrated in FIG. 6B, the material supply controller 262, in response to an instruction for supplying the material, sends the second material supply device 250 a signal for causing the driving unit 232 to drive the drive screw shafts 231c and move the movable head 231b to a predetermined position. This moves the movable head 231b. Upon the movable head 231b reaching the predetermined position, the ejection drive section 251a of the second material ejection section 251 receives a material ejection drive signal, and the second ejection nozzle 251b ejects the material stored in the second material supply unit 252.

In order to make a transition for the supply of material from the first material supply device 240, the material supply controller 262 sends a signal for stopping the supply of material from the second material supply device 250, and outputs a signal for causing the driving unit 232 to drive the drive screw shafts 231c and move the movable head 231b to a predetermined position. This moves the movable head 231b. Upon the movable head 231b reaching the predetermined position, the ejection drive section 241a of the first material ejection section 241 receives a material ejection drive signal, and the ejection nozzle 241b ejects the material stored in the first material supply unit 242.

By the reciprocal movement of the movable head 231b along the S direction, the desired sinter material can be ejected from the first material supply device 240 or the second material supply device 250 to the irradiation region of the lasers L1 and L2 from the laser irradiation sections 51a and 51b. The present embodiment has been described through the case of ejecting two kinds of sinter materials. However, the invention is not limited to this, and may include a plurality of material supply devices for different materials.

The three-dimensional forming apparatus 2000 according to the present embodiment has been described as including the first material ejection section 241 and the second material ejection section 251 for two sinter materials. However, for example, a channel switching device for switching the supply material may be provided at some point in the supply tube 42a in the configuration of the three-dimensional forming apparatus 1000 according to First Embodiment so that more than one sinter material can be ejected from the single material ejection section 41.

### Third Embodiment

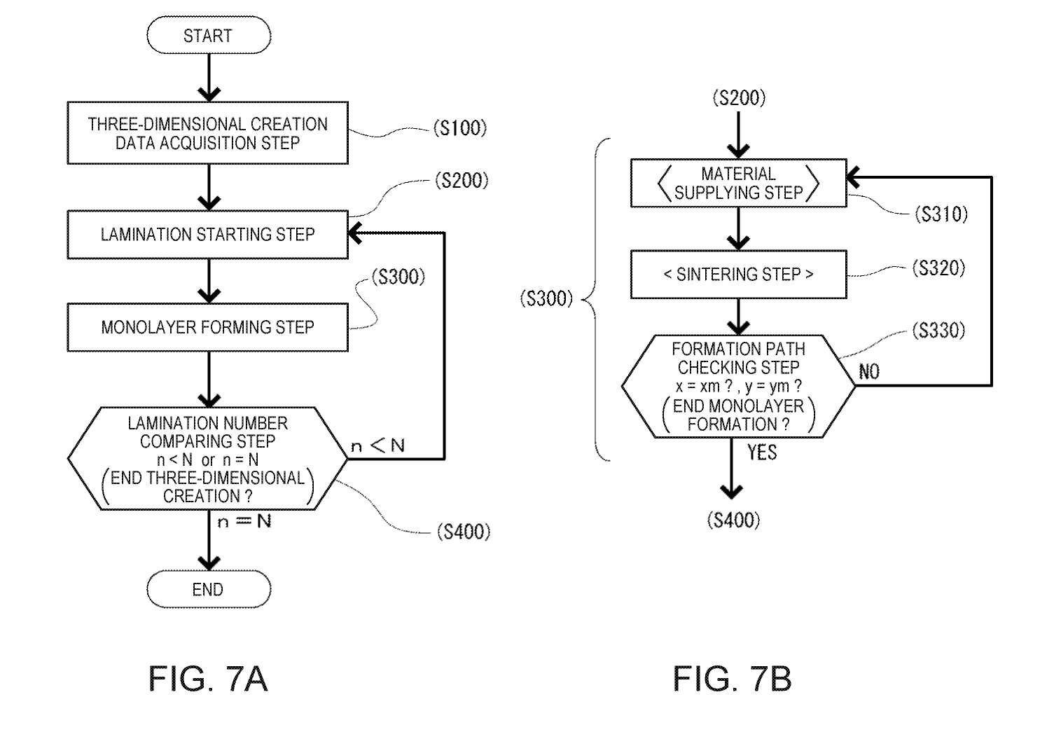

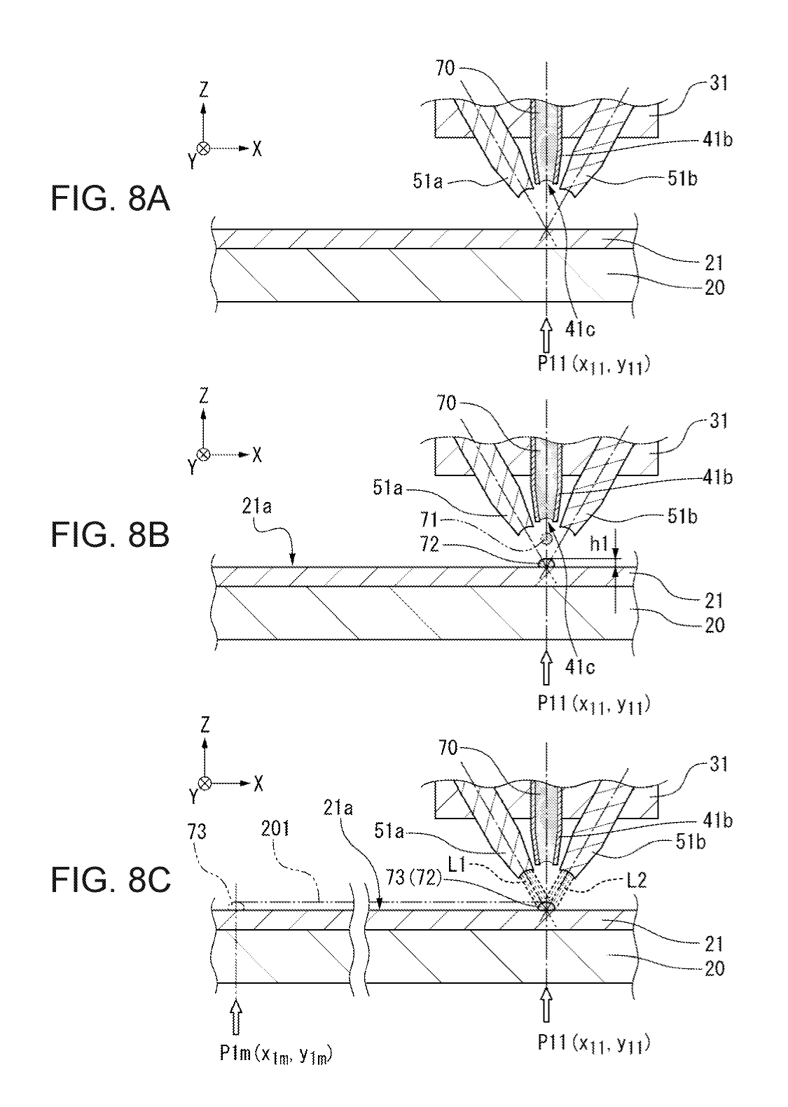

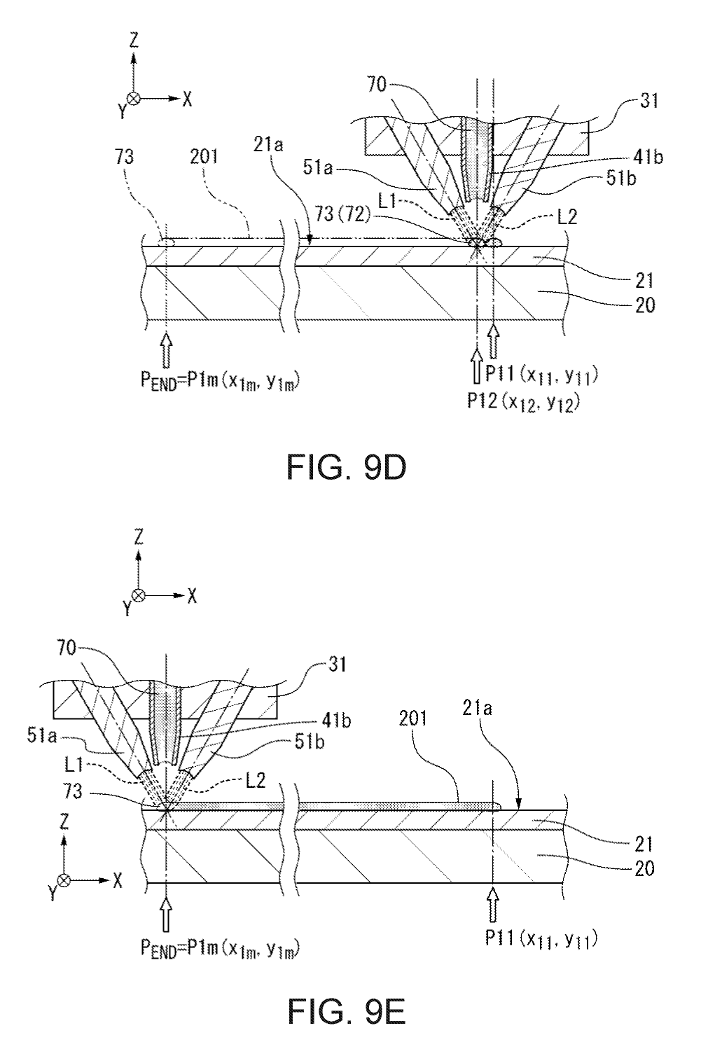

In Third Embodiment, a three-dimensional forming method for forming a three-dimensional-shape object using the three-dimensional forming apparatus 1000 according to First Embodiment is described. FIG. 7A is a flowchart representing the three-dimensional forming method according to Third Embodiment. FIG. 7B is a flowchart representing details of the monolayer forming step (S300) shown in FIG. 7A. FIGS. 8A to 8C and FIGS. 9D and 9E are partial cross sectional views explaining the three-dimensional forming method according to the present embodiment.

### Three-Dimensional Creation Data Acquisition Step

As shown in FIG. 7A, the three-dimensional forming method according to the present embodiment performs a three-dimensional creation data acquisition step (S100), in which the three-dimensional creation data of the three-dimensional-shape object 200 is acquired by the control unit 60 (see FIG. 1) from, for example, a personal computer (not illustrated). Upon acquiring the three-dimensional creation data acquired in the three-dimensional creation data acquisition step (S100), the control unit 60 sends control data to the stage controller 61, the material supply controller 62, and the laser oscillator 52. The sequence then goes to a lamination starting step.

### Lamination Starting Step

In the lamination starting step (S200), the head 31 is disposed at a predetermined position relative to the sample plate 21 mounted on the stage 20, as shown in FIG. 8A representing the three-dimensional forming method. Here, the stage 20 with the sample plate 21 is moved in such a manner that the airborne material Mf (see FIGS. 2A and 2B) as droplets of sinter material ejected through the ejection orifice 41c of the ejection nozzle 41b of the material ejection section 41 lands on a coordinate position P11 (x11, y11) on the X-Y plane (see FIG. 1) of the stage 20 representing the starting point of the creation based on the three-dimensional creation data. Upon starting the formation of the three-dimensional object, the sequence goes to a monolayer forming step.

### Monolayer Forming Step

The monolayer forming step (S300) includes a material supplying step (S310), and a sintering step (S320), as shown in FIG. 7B. First, in the material supplying step (S310), the ejection nozzle 41b ejects a supply material 70 (sinter material) through the ejection orifice 41c in droplets of airborne material 71 in the direction of gravity (see FIGS. 2A and 2B) toward the sample plate 21 that has been moved in the lamination starting step (S200) and facing the ejection nozzle 41b held to the head 31 at the predetermined position P11 (x11, y11), as illustrated in FIG. 8B. The supply material 70 is a slurry- or paste-like material that is prepared by kneading a solvent and a thickener (binder) with the raw material metal of the three-dimensional-shape object 200. The raw material metal may be, for example, a simple powder of stainless steel or a titanium alloy, or a mixed powder of metals that cannot be easily alloyed such as stainless steel and copper (Cu), stainless steel and a titanium alloy, and a titanium alloy and cobalt (Co) or chromium (Cr).

The airborne material 71 lands on the top surface 21a of the sample plate 21, and forms a unit droplet material (hereinafter, “unit material 72”) at the P11 (x11, y11) position on the top surface 21a. This completes the material supplying step (S310). The airborne material 71 is ejected through the ejection orifice 41c into air in the direction of gravity, and accurately lands on the intended P11 (x11, y11) position as the unit material 72. Here, the sample plate 21 is preferably heated. By heating the sample plate 21, the solvent contained in the unit material 72 can evaporate, and the unit material 72 becomes less fluidic than the supply material 70. This makes the airborne material 71 less likely to wet and spread along the top surface 21a upon landing on the top surface 21a of the sample plate 21, and the unit material 72 can have a sufficient height h1 (overlay) relative to the top surface 21a of the sample plate 21.

The sintering step (S320) starts upon the unit material 72 being disposed on the top surface 21a. In the sintering step (S320), as illustrated in FIG. 8C, the laser irradiation sections 51a and 51b apply lasers L1 and L2 toward the unit material 72 in directions that cross the direction of gravity (see FIGS. 2A and 2B). The energy (heat) of the lasers L1 and L2 evaporates the solvent and the thickener contained in the unit material 72, and the metal powder particles bind to one another by being sintered or melted, and form a unit sinter 73 as a metal agglomerate at the P11 (x11, y11) position. The irradiation conditions of lasers L1 and L2 are set according to factors such as the composition and the volume of the unit material 72, and the laser irradiation is stopped after the unit material 72 is irradiated with the set dose.

The material supplying step (S310) and the sintering step (S320) are repeated to form the first partial object 201 as a first monolayer, as will be described later.

The material supplying step (S310) and the sintering step (S320) for the formation of the partial object 201 are repeated m times with the movement of the stage 20, and the mth unit sinter 73 is formed at the coordinate PEND=P1m (x1m, y1m) position representing the end of the partial object 201 on the stage 20.

Upon forming the unit sinter 73 at the P11 (x11, y11) position, a formation path checking step (S330) is performed that determines whether the material supplying step (S310) and the sintering step (S320) have been repeated m times to form the partial object 201, specifically whether the ejection nozzle 41b has reached the coordinate position PEND=P1m (x1m, y1m) of the stage 20. If it is determined in the formation path checking step (S330) that the repeat number m has not been reached, specifically that the ejection nozzle 41b has not reached the coordinate position PEND=P1m (x1m, y1m) of the stage 20 (NO), the sequence returns to the material supplying step (S310) (FIG. 9D), and the stage 20 is moved so that the ejection nozzle 41b faces the P12 (x12, y12) position where the next unit material 72 will be formed. Upon the ejection nozzle 41b meeting the P12 (x12, y12) position, the material supplying step (S310) and the sintering step (S320) are performed to form the unit sinter 73 at the P12 (x12, y12) position.

The material supplying step (S310) and the sintering step (S320) are repeated m times to form the partial object 201, as illustrated in FIG. 9E. The monolayer forming step (S300) is finished upon determining that the ejection nozzle 41b with the repeat number m is facing the stage 20 at the coordinate PEND=P1m (x1m, y1m) position (YES).

### Lamination Number Comparing Step

Upon forming the first partial object 201 as the first monolayer in the monolayer forming step (S300), the sequence goes to the lamination number comparing step (S400), in which the lamination number is compared with the creation data obtained in the three-dimensional creation data acquisition step (S100). In the lamination number comparing step (S400), the number N of partial object layers of the three-dimensional-shape object 200 is compared with the number n of partial object layers present in the monolayer forming step (S300) immediately before the lamination number comparing step (S400).

If it is determined in the lamination number comparing step (S400) that n=N, it is determined that the three-dimensional-shape object 200 is complete, and the three-dimensional formation is finished. On the other hand, if n<N, the sequence restarts from the lamination starting step (S200).

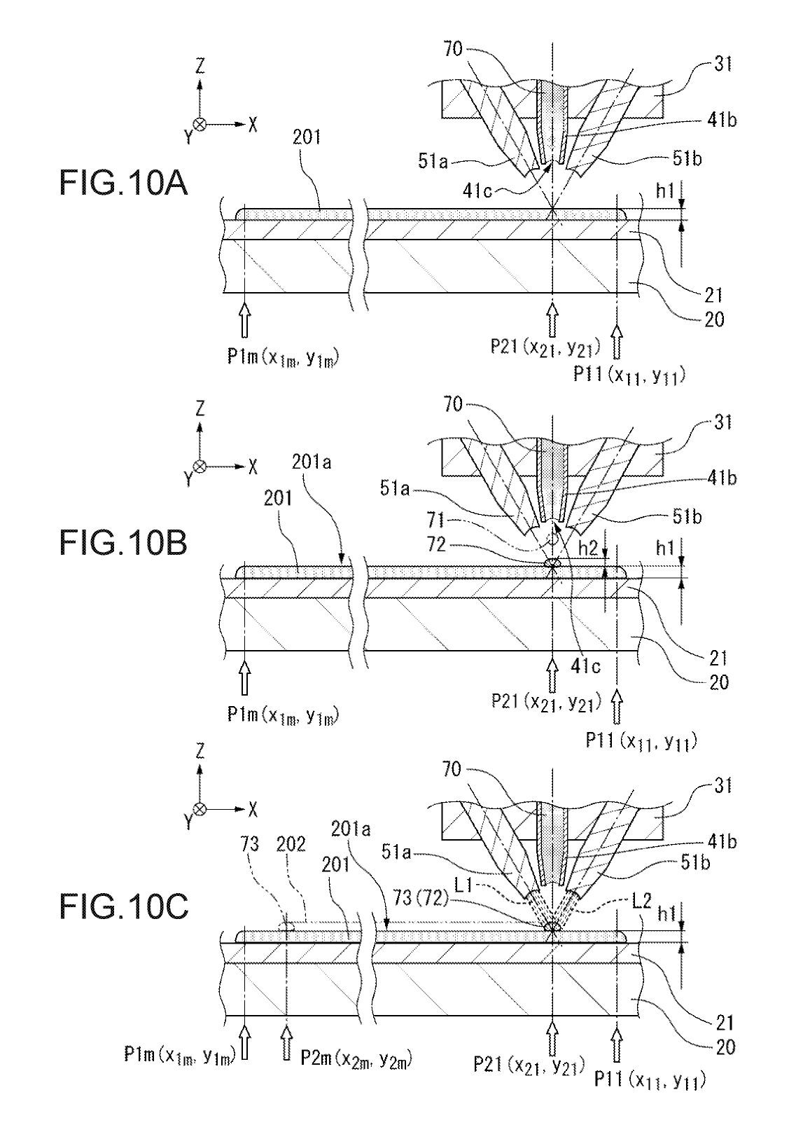

FIG. 10A is a cross sectional view representing how the second partial object 202 is formed as a second monolayer. First, as illustrated in FIG. 10A, the lamination starting step (S200) is performed again. Here, the stage 20 is moved in the direction of Z axis by a distance that corresponds to the thickness h1 of the first partial object 201, relative to the ejection orifice 41c and the laser irradiation sections 51a and 51b. Here, the stage 20 with the sample plate 21 is moved in such a manner that the airborne material 71 (see FIGS. 2A and 2B) as droplets of sinter material ejected through the ejection orifice 41c of the ejection nozzle 41b of the material ejection section 41 lands on a coordinate position P21 (x21, y21) of the stage 20 representing the starting point of the second layer creation based on the three-dimensional creation data. The sequence then goes to the monolayer forming step (S300) to start the formation of the second layer of the three-dimensional object.

The monolayer forming step (S300) is performed in the same manner as in the formation of the first partial object 201 described above in FIGS. 8A to 8C and FIGS. 9D and 9E, as follows. First, in the material supplying step (S310), the ejection nozzle 41b ejects the supply material 70 (sinter material) through the ejection orifice 41c in droplets of airborne material 71 toward the upper portion 201a of the first partial object 201 on the sample plate 21 that has been moved with the stage 20 in the lamination starting step (S200) and facing the ejection nozzle 41b held to the head 31 at the predetermined position P21 (x21, y21), as illustrated in FIG. 10B.

The airborne material 71 lands on the upper portion 201a of the partial object 201, and forms a unit droplet material 72 (hereinafter, “unit material 72”) at the P21 (x21, y21) position on the upper portion 201a. This completes the material supplying step (S310), forming the unit material 72 of height h2 (overlay) on the upper portion 201a of the partial object 201.

The sintering step (S320) starts upon the unit material 72 being disposed on the upper portion 201a of the partial object 201. In the sintering step (S320), as illustrated in FIG. 10C, the laser irradiation sections 51a and 51b apply lasers L1 and L2 toward the unit material 72. The energy (heat) of the lasers L1 and L2 sinters the unit material 72, and forms the unit sinter 73. The material supplying step (S310) and the sintering step (S320) are repeated to form the second partial object 202 on the upper portion 201a of the first partial object 201. The material supplying step (S310) and the sintering step (S320) for the formation of the partial object 202 are repeated m times with the movement of the stage 20, and the mth unit sinter 73 is formed at the coordinate PEND=P2m (x2m, y2m) position representing the end of the partial object 203 on the stage 20.

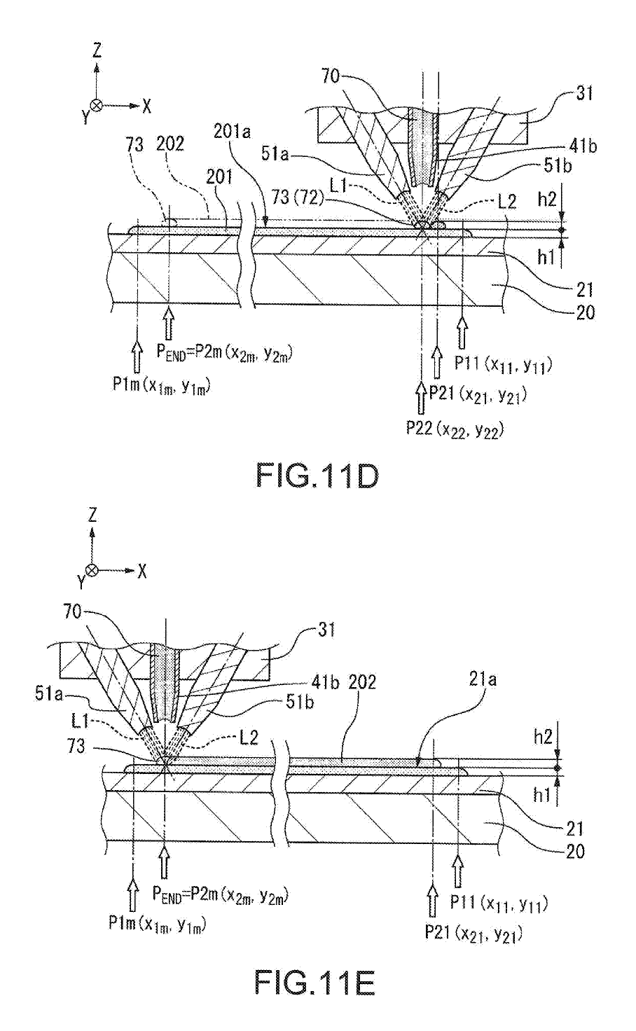

Upon forming the unit sinter 73 at the P21 (x21, y21) position, a formation path checking step (S330) is performed that determines whether the material supplying step (S310) and the sintering step (S320) have been repeated m times to form the second partial object 202, specifically whether the ejection nozzle 41b has reached the coordinate position PEND=P2m (x2m, y2m) of the stage 20. If it is determined in the formation path checking step (S330) that the repeat number m has not been reached, specifically that the ejection nozzle 41b has not reached the coordinate position PEND=P2m (x2m, y2m) of the stage 20 (NO), the sequence returns to the material supplying step (S310) (FIG. 11D), and the stage 20 is moved so that the ejection nozzle 41b faces the P22 (x22, y22) position where the next unit material 72 will be formed. Upon the ejection nozzle 41b meeting the P22 (x22, y22) position, the material supplying step (S310) and the sintering step (S320) are performed to form the unit sinter 73 at the P22 (x22, y22) position.

The material supplying step (S310) and the sintering step (S320) are repeated m times to form the second partial object 202, as illustrated in FIG. 11E. The monolayer forming step (S300) is finished upon determining that the ejection nozzle 41b with the repeat number m is facing the stage 20 at the coordinate PEND=P2m (x2m, y2m) position (YES).

The sequence then goes to the lamination number comparing step (S400) again, and the lamination starting step (S200) and the monolayer forming step (S300) are repeated until n=N. The formation of a three-dimensional-shape object with the three-dimensional forming apparatus 1000 according to First Embodiment proceeds in the manner described above. Note that the language “laminating” in Application Examples above refers to performing the lamination starting step (S200) and the monolayer forming step (S300) to form the second partial object 202 as the second monolayer on the first partial object 201 formed as the first monolayer, and this step is repeated until the lamination number comparing step (S400) determines that n=N.

### Fourth Embodiment

A three-dimensional forming method according to Fourth Embodiment is described below. In the three-dimensional forming method according to Third Embodiment, it may not be possible to form the unit material 72 in the material supplying step (S310) of the monolayer forming step (S300) (see FIG. 10B) when the three-dimensional-shape object has an overhang portion because an overhang portion lacks an underlying partial object where the airborne material 71 lands. It may be possible to land the unit material 72 in a manner allowing it to cover and join the unit sinter 73 formed at the P21 (x21, y21) position shown in FIG. 11D. However, in the absence of an underlying partial object, the unit material 72 may deform by hanging down in the direction of gravity. This is because the unit material 72 before sintering is a slurry- or paste-like soft material as a kneaded mixture of a solvent and a thickener with the raw material metal, for example, a simple powder of stainless steel or a titanium alloy, or a mixed powder of metals that cannot be easily alloyed, for example, stainless steel and copper (Cu), stainless steel and a titanium alloy, or a titanium alloy and cobalt (Co) or chromium (Cr).

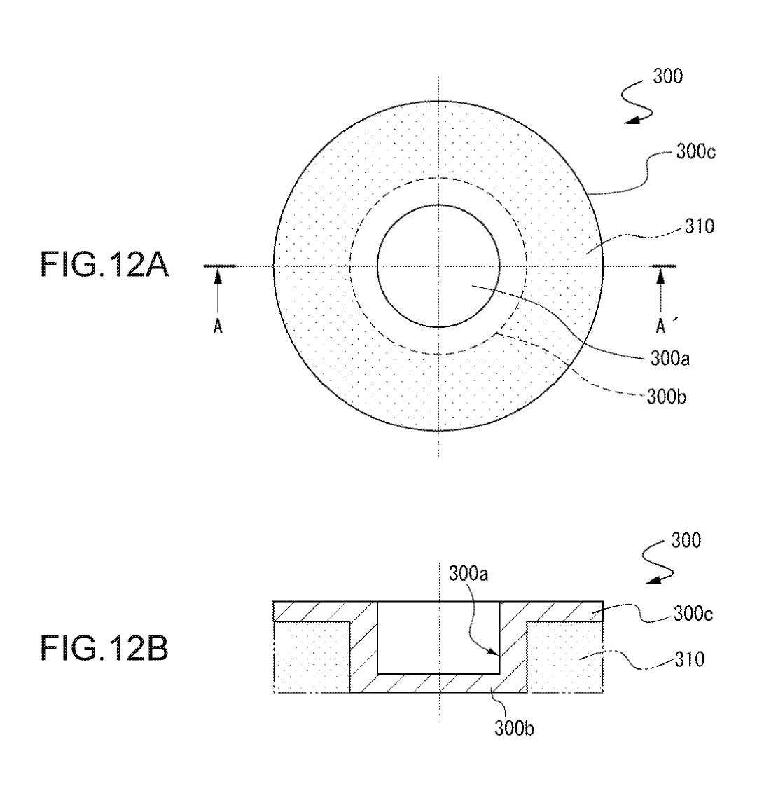

The three-dimensional forming method according to Fourth Embodiment is a method that forms a three-dimensional-shape object without deforming an overhang portion. The same steps described in the three-dimensional forming method according to Third Embodiment above are given the same reference numerals, and will not be described further. For convenience of explanation, the three-dimensional forming method according to Fourth Embodiment will be described using a three-dimensional-shape object 300 of a simple shape as an example, such as that shown in the plan external view of FIG. 12A, and the cross sectional view of FIG. 12B taken at A-A′ of FIG. 12A. However, the invention is not limited to such a shape, and is applicable to a range of objects with an overhang portion.

As illustrated in FIGS. 12A and 12B, the three-dimensional-shape object 300 has a columnar base portion 300b with a depression 300a, and a flange portion 300c (overhang portion) that extends outwardly from the base portion 300b at the depression opening side of the base portion 300b. In forming the three-dimensional-shape object 300, the three-dimensional forming method according to Fourth Embodiment creates the support portion 310 that is removed during the process, using data for creating the portion from the flange portion 300c down to the bottom portion of the base portion 300b (from the top to the bottom in FIG. 12B), in addition to the three-dimensional creation data for the three-dimensional-shape object 300.

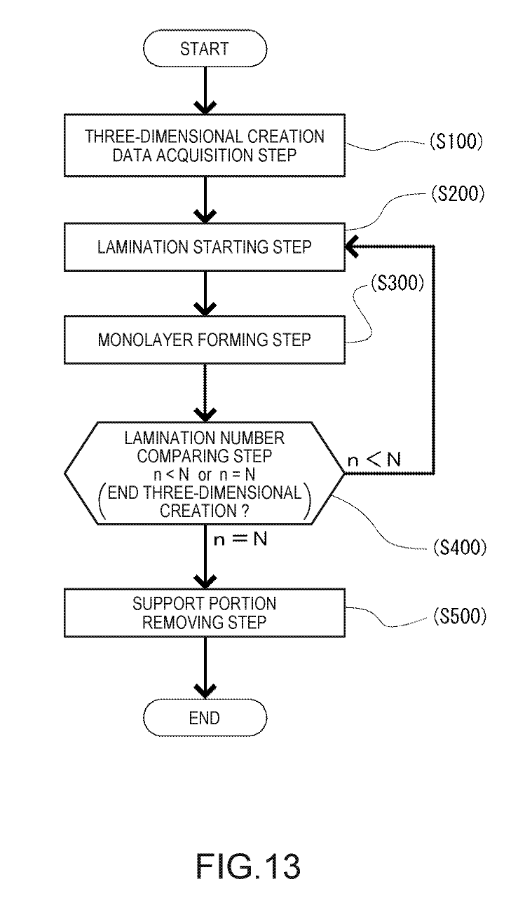

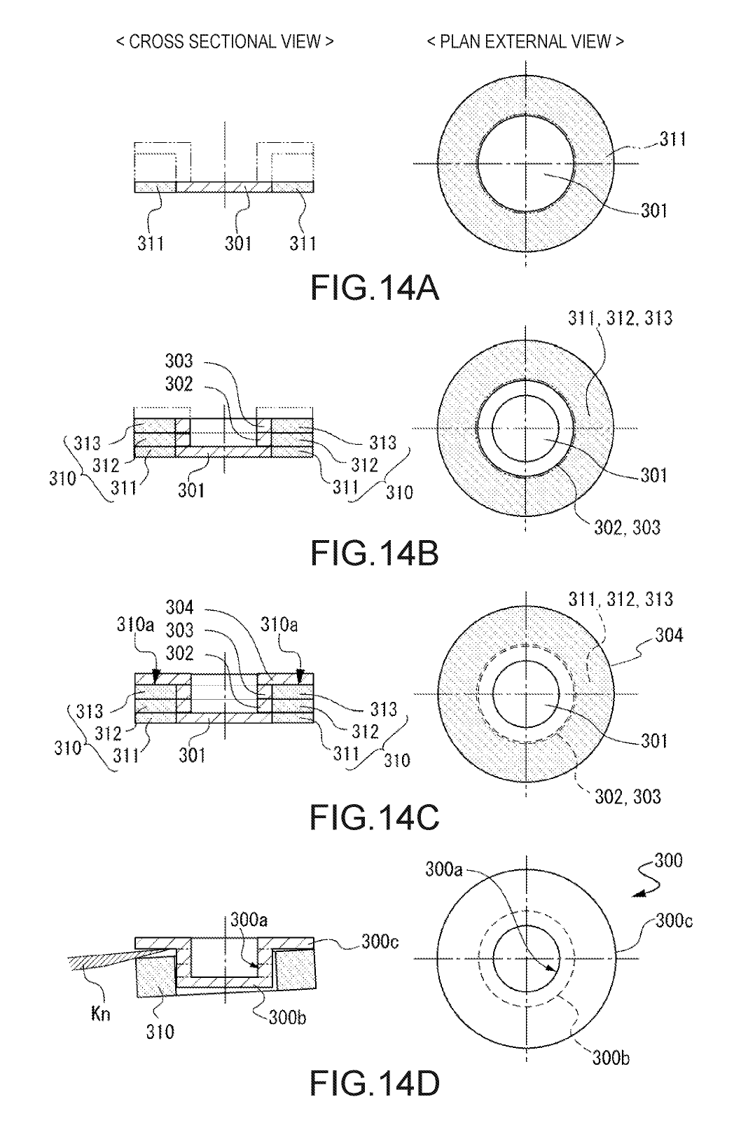

FIG. 13 is a flowchart representing the method for forming the three-dimensional-shape object 300 shown in FIGS. 12A and 12B. FIGS. 14A to 14D are diagrams representing the method for forming the three-dimensional-shape object 300 according to the flowchart of FIG. 13. FIGS. 14A to 14D shows partial cross sectional views on the left, and plan external views on the right. The three-dimensional-shape object 300 of the present embodiment will be described through the case of forming four layers. However, the invention is not limited to this embodiment.

First, as illustrated in FIG. 14A, the three-dimensional forming method according to Third Embodiment forms a partial object 301 as the first layer on the sample plate 21 (not illustrated). The step of forming the partial object 301 also forms a partial support portion 311 for the first layer. The sintering step (S320) in the monolayer forming step (S300) described in FIGS. 8A to 8C and FIGS. 9D and 9E is not performed for the partial support portion 311, and the monolayer forming step (S300) is performed while the layer is the unit material 72, specifically while the layer is unsintered or unmelted.

The monolayer forming step (S300) is repeated to form the second- and third-layer partial objects 302 and 303, as illustrated in FIG. 14B. The step of forming the partial objects 302 and 303 also forms partial support portions 312 and 313 for the second and third layers. As with the case of the partial support portion 311, the sintering step (S320) in the monolayer forming step (S300) is not performed for the partial support portions 312 and 313, and the monolayer forming step (S300) is performed while the layer is the unit material 72, specifically while the layer is unsintered or unmelted. The partial support portions 311, 312, and 313 form the support portion 310.

Thereafter, as illustrated in FIG. 14C, the fourth layer partial object 304 is formed that forms the flange portion 300c. The partial object 304 is formed by being supported on an end surface 310a of the support portion 310 formed by the partial support portions 311, 312, and 313. With the end surface 310a formed as a landing surface of the unit material 72 (see FIGS. 8A to 8C), the fourth layer partial object 304 as the flange portion 300c can be formed with precision in the manner described above.

As illustrated in FIG. 14D, the support portion 310 is removed from the three-dimensional-shape object 300 in the support portion removing step (S500) upon forming the three-dimensional-shape object 300. Because the support portion 310 is an uncalcined material, the support portion 310 can be physically removed in the support portion removing step (S500), using, for example, a sharp blade Kn, as illustrated in FIG. 14D. The support portion 310 also may be removed from the three-dimensional-shape object 300 by dipping the object in a solvent, and dissolving the thickener contained in the material.

As described above, in forming the three-dimensional-shape object 300 having the flange portion 300c as an overhang portion, the flange portion 300c can be prevented from being deformed in the direction of gravity by being supported with the support portion 310 formed during the formation of the three-dimensional-shape object 300. The support portion 310 shown in FIGS. 12A and 12B is not limited to the form in which the flange portion 300c is supported over the whole surface as shown in the figures, and the shape, the size, and other features of the support portion 310 may be appropriately set according to factors such as the shape and the material composition of the object.

The specific configuration for implementing the invention may be appropriately varied within a range of apparatuses or methods that are applicable to achieve the objects of the invention.

The entire disclosure of Japanese patent No. 2015-053023, filed Mar. 17, 2015 is expressly incorporated by reference herein.

What is claimed is:

1. A three-dimensional forming apparatus comprising:
a stage;
a material supplying unit that supplies a sinter material containing a metal powder and a binder toward the stage;
an energy irradiating unit that supplies the sinter material supplied from the material supplying unit with an energy capable of sintering the sinter material; and
a driving unit that enables the material supplying unit and the energy irradiating unit to three-dimensionally move relative to the stage,
wherein the material supplying unit includes a material ejection section that supplies the sinter material in a predetermined amount,
the energy irradiating unit includes an energy irradiation section that emits the energy, and
the material ejection section and the energy irradiation section are held to a single holder.

2. The apparatus according to claim 1, wherein the energy irradiating unit applies the energy in a direction that crosses the direction of gravity.

3. The apparatus according to claim 1, wherein the sinter material is ejected in a droplet through an orifice of the material ejection section.

4. The apparatus according to claim 1, wherein the energy irradiation section includes a plurality of the energy irradiation sections.

5. The apparatus according to claim 1, wherein the material supplying unit includes at least a material supply section that supplies the sinter material to the material ejection section having a material ejection orifice facing the stage,
the material supply section including a plurality of the material supply sections, and supplying the sinter material as two or more sinter materials of different compositions.

6. The apparatus according to claim 1, wherein the energy irradiating unit is a laser irradiation unit.

7. A three-dimensional forming method comprising:
forming a monolayer by
supplying a sinter material containing a metal powder and a binder, and
sintering the sinter material with an energy capable of sintering the sinter material and that is supplied toward the sinter material supplied in the supplying; and
laminating another monolayer on the monolayer formed in the forming by forming the another monolayer by repeating the forming,
wherein the laminating is repeated a predetermined number of times to form a three-dimensional-shape object, and
in the forming, the sinter material is ejected in a droplet in the supplying, and the sintering is performed to a landed unit droplet of the sinter material over a predetermined formation region of the monolayer.

8. The method according to claim 7, wherein the energy supplied in the sintering is supplied by being applied in a direction that crosses the direction of gravity.

9. The method according to claim 7,
wherein a support portion that supports the monolayer is formed in the forming, and
the support portion is an unsintered portion unirradiated with the energy supplied in the sintering.

10. The method according to claim 9, comprising removing the support portion.
